(19) United States
(12) Patent Application Publication
(10) Pub. No.: US 2007/0181181 A1
(43) Pub. Date: Aug. 9, 2007

(54) GAS SUPPLY SYSTEM, SUBSTRATE PROCESSING APPARATUS AND GAS SUPPLY METHOD

(75) Inventor: Kenetsu MIZUSAWA, Nirasaki-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: TOKYO ELECTRON LIMITED, Tokyo (JP)

(21) Appl. No.: 11/668,688

(22) Filed: Jan. 30, 2007

Related U.S. Application Data
(60) Provisional application No. 60/773,651, filed on Feb. 16, 2006.

(30) Foreign Application Priority Data
Feb. 8, 2006 (JP) 2006-031731

(51) Int. Cl. F17D 1/00

(52) U.S. Cl. 137/1; 438/5

(57) ABSTRACT

A gas supply system includes a first and a second branch line branched from a processing gas supply line to be respectively connected with a first and a second gas introduction section for introducing a gas from different portions in a processing chamber and a branch flow control unit for controlling branch flows of the processing gas distributed from the processing gas supply line to the first and the second branch line based on pressures in the first and the second processing gas branch line. The gas supply system further includes an additional gas supply unit for supplying an additional gas and an additional gas supply line for allowing the additional gas to flow therein. The first or second gas introduction section is divided into a processing gas introduction section connected with the branch lines and an additional gas introduction section connected with the additional gas supply line.

### FIELD OF THE INVENTION

The present invention relates to a gas supply system for supplying a gas into a processing chamber, a substrate processing apparatus and a gas supply method.

### BACKGROUND OF THE INVENTION

A substrate processing apparatus is configured to perform specific processes such as a film forming process, an etching process and the like on a substrate to be processed (hereinafter, simply referred to as “substrate”) such as a semiconductor wafer, a liquid crystal substrate or the like.

As for such a substrate processing apparatus, there has been known a plasma processing apparatus, for example. The plasma processing apparatus includes, inside a processing chamber, a lower electrode serving also as a mounting table for mounting thereon a substrate and an upper electrode serving also as a shower head for injecting a gas toward the substrate. Such a parallel plate type plasma processing apparatus is configured to perform specific processes such as a film forming process, an etching process and the like with the use of a plasma generated by applying a high frequency power between both electrodes while supplying a specific gas through the shower head onto the substrate in the processing chamber.

In performing on the substrate specific processes such as a film forming process, an etching process and the like, there has been demanded to improve in-surface uniformity in processing the substrate by making processing characteristics (e.g., an etching rate, an etching selectivity, a film forming rate and the like) uniform in a surface of the substrate.

In such a view, in Japanese Patent Laid-open Application Nos. H8-158072 and H9-45624, there have been proposed techniques for supplying a processing gas of optional composition at an optional flow rate to plural portions on a substrate surface via gas supply lines individually connected with a plurality of gas chambers formed by dividing the inside of the shower head. In accordance with such techniques, the in-surface uniformity in etching the substrate can be improved by locally adjusting a gas concentration on the substrate surface.

A gas used for an actual substrate processing is obtained by mixing plural types of gases, e.g., a processing gas directly participating in a substrate processing, a gas for controlling a deposition of reaction products generated in the substrate processing, a carrier gas such as an inactive gas or the like, and the like. The types of gases are appropriately selected depending on target materials on the substrate or processing conditions. Therefore, there arises a need to perform a flow rate control by using a mass flow controller provided on each of the gas supply lines respectively connected with the gas chambers in the shower head, as disclosed in Japanese Patent Laid-open Application No. H9-45624.

However, in such a conventional configuration, although the gases supplied to plural portions on a substrate surface include common gases, each of the gases supplied from the gas chambers has its own gas supply system and, also, flow rates thereof are individually controlled. Accordingly, a line configuration and a flow rate control in each of the lines become complicated, which results in requiring a large space for the lines and an increased burden of control.

Further, even if the gases can be supplied from plural portions in the processing chamber by a simple control operation, when a flow rate ratio (distribution ratio) of the processing gases supplied to the plural portions changes due to a pressure variation, for example, during the introduction of the gases, the desired in-surface uniformity cannot be achieved.

### SUMMARY OF THE INVENTION

It is, therefore, an object of the present invention to provide a gas supply system and the like, capable of achieving desired in-surface uniformity by supplying a gas from plural portions in a processing chamber with a simple line configuration and a simple control operation without being affected by a pressure variation or the like.

In accordance with a first aspect of the invention, there is provided 1. A gas supply system for supplying a gas into a processing chamber for processing a substrate to be processed, the system including: a processing gas supply unit for supplying a processing gas for processing the substrate to be processed; a processing gas supply line for allowing the processing gas from the processing gas supply unit to flow therein; a first and a second branch line branched from the processing gas supply line to be respectively connected with a first and a second gas introduction section for introducing a gas from different portions in the processing chamber; a branch flow control unit for controlling branch flows of the processing gas distributed from the processing gas supply line to the first and the second branch line based on pressures in the first and the second processing gas branch line; an additional gas supply unit for supplying an additional gas; and an additional gas supply line for allowing the additional gas to flow therein, wherein the first gas introduction section or the second gas introduction section is divided into a processing gas introduction section connected with the branch lines and an additional gas introduction section connected with the additional gas supply line. The additional gas introduction section introduces the additional gas into the processing chamber to be added to the processing gas introduced from the processing gas introduction section into the processing chamber.

In accordance with a second aspect of the invention, there is provided a substrate processing apparatus including: a processing chamber for processing a substrate to be processed; and a gas supply system for supplying a gas into the processing chamber, wherein the gas supply system comprises a first and a second gas introduction section for introducing a gas from different portions in the processing chamber; a processing gas supply unit for supplying a processing gas for processing the substrate to be processed; a processing gas supply line for allowing the processing gas from the processing gas supply unit to flow therein; a first and a second branch line branched from the processing gas supply line to be respectively connected with the first and the second gas introduction section; a branch flow control unit for controlling branch flows of the processing gas distributed from the processing gas supply line to the first and the second branch line based on pressures in the first and the second branch line; an additional gas supply unit for supplying an additional gas; an additional gas supply for allowing the additional gas from the additional gas supply unit to flow therein, wherein either the first gas introduction section or the second gas introduction section is divided into a processing gas introduction section connected with the branch lines and an additional gas introduction section connected with the additional gas supply line.

In accordance with a third aspect of the invention, there is provided a gas supply method using a gas supply system for supplying a gas into a processing chamber for processing a substrate to be processed, the gas supply system including a processing gas supply unit for supplying a processing gas for processing the substrate to be processed; a processing gas supply line for allowing the processing gas from the processing gas supply unit to flow therein; a first and a second branch line branched from the processing gas supply line to be respectively connected with a first and a second gas introduction section for introducing a gas from different portions in the processing chamber; a branch flow control unit for adjusting branch flows of the processing gas distributed from the processing gas supply line to the first and the second branch line based on pressures in the first and the second branch line; an additional gas supply unit for supplying an additional gas; and an additional gas supply line for allowing the additional gas from the additional gas supply unit to flow therein, wherein the first gas introduction section or the second gas introduction section is divided into a processing gas introduction section connected with the branch lines and an additional gas introduction section connected with the additional gas supply line, the method including the steps of: controlling, before processing the substrate to be processed, the processing gas supply unit and the additional gas supply unit to initiate supplies of the processing gas and the additional gas; and controlling the branch flow control unit to adjust the branch flows of the processing gas such that a ratio of the pressure in the branch lines becomes a target pressure ratio.

In accordance with the present invention, the processing gas from the processing gas supply unit is distributed to the first and the second branch line and, then, the processing gas from the first and the second branch line is introduced into the processing chamber via the first and the second gas introduction section, respectively. Further, in case the first gas introduction section is divided into the processing gas introduction section and the additional gas introduction section, the additional gas from the additional gas supply unit is introduced via the additional gas introduction section and then added to the processing gas introduced via the processing gas introduction section, so that the processing gas whose composition and/or flow rate is adjusted is supplied to a specific region on the substrate to be processed. In this way, since the processing gas containing same components is supplied from the common processing gas supply unit to each of the branch lines and the composition and/or the flow rate of the processing gas flowing in any one of the first and the second branch line can be adjusted by adding thereto an additional gas as desired, the number of lines can be minimized, which accomplishes a simple line configuration and a simple flow rate control.

The additional gas is supplied from the additional gas introduction section into the processing chamber via the additional gas supply line of a different system from the processing gas supply line, so that the pressures in the first and the second branch line are not affected thereby. Therefore, a flow rate ratio (distribution ratio) of the processing gases flowing in the first and the second branch line is not changed between before and after the additional gas is supplied, which results in desired in-surface uniformity.

The second gas introduction section is arranged to surround the first gas introduction section and divided into the processing gas introduction section and the additional gas introduction section, the processing gas introduction section being arranged to surround the first gas introduction section and the additional gas introduction section being arranged to surround the processing gas introduction section. Since the additional gas introduction section of the second gas introduction section is disposed at the outermost side, the additional gas may be injected from the additional gas introduction section to surround a plasma generation space depending on a flow rate thereof. This makes it possible to confine a plasma and hence to stabilize plasma characteristics.

Further, there may be provided a control unit for controlling, before processing the substrate, the processing gas supply unit and the additional gas supply unit to initiate supplies of the processing gas and the additional gas and then controlling the branch flow control unit to adjust branch flows of the processing gas such that a ratio of the pressures in the branch lines becomes a target pressure ratio. In the present invention, the additional gas is supplied from the additional gas introduction section into the processing chamber via the additional gas supply line of a different system from the first and the second branch line, so that the pressure of the processing gas is not affected by the supply of the additional gas. For this reason, the supplies of the processing gas and the additional gas can be simultaneously initiated, which leads to a simpler control operation and a shortened gas supply process time. As a result, deterioration of the throughput can be avoided.

The first gas introduction section may be arranged to supply the gas toward a central region on a surface of the substrate to be processes in the processing chamber, and the second processing gas branch line may be arranged to supply the gas toward an outer peripheral region surrounding the central region on the surface of the substrate to be processed. Accordingly, it is possible to improve processing uniformity in the central region and the outer peripheral region of the substrate to be processed.

The branch flow control unit may have valves for controlling a flow rate of the processing gas flowing in the respective branch lines and pressure sensors for detecting the pressures in the branch lines, and a ratio of flow rates of the processing gas flowing through the respective branch lines may be adjusted by controlling opening degrees of the valves based on the pressures detected by the pressure sensors.

The processing gas supply unit may have a plurality of gas supply sources to supply to the processing gas supply line the processing gas obtained by mixing gases from the gas supply sources at a specific flow rate ratio. Moreover, the additional gas supply unit may have a plurality of gas supply sources to supply to the additional gas supply line the additional gas obtained by selecting a gas from the gas supply sources or by mixing gases from the gas supply sources at a specific gas flow rate ratio. With such arrangements, since the processing gas containing a plurality of same components is supplied from the processing gas supply unit to each of the branch lines and, then, the composition and/or the flow rate of the processing gas flowing in any one of the first and the second branch line can be adjusted by adding thereto additional gas as desired, the number of lines can be minimized, which accomplishes a simple line configuration.

In accordance with a fourth aspect of the invention, there is provided a gas supply system for supplying a gas into a processing chamber for processing a substrate to be processed, the system including: a processing gas supply unit for supplying a processing gas for processing the substrate to be processed; a processing gas supply line for allowing the processing gas from the processing gas supply unit to flow therein; a first to an n-th branch line branched from the processing gas supply line to be respectively connected with a first to an n-th gas introduction section for introducing a gas from different portions in the processing chamber; a branch flow control unit for controlling branch flows of the processing gas distributed from the processing gas supply line to the first to the n-th branch line based on pressures in the first to the n-th branch line; an additional gas supply unit for supplying an additional gas; and an additional gas supply line for allowing the additional gas to flow therein, wherein at least one of the first to the n-th gas introduction section is divided into a processing gas introduction section for introducing the processing gas from the branch lines into the processing chamber and an additional gas introduction section for introducing the additional gas from the additional gas supply line into the processing chamber to be added to the processing gas.

In accordance with a fifth aspect of the invention, there is provided a gas supply system for supplying a gas into a processing chamber for processing a substrate to be processed, the system including: a processing gas supply unit for supplying a processing gas for processing the substrate to be processed; a processing gas supply line for allowing the processing gas from the processing gas supply unit to flow therein; a plurality of branch lines branched from the processing gas supply line to be respectively connected with a plurality of gas introduction sections for introducing a gas from different portions in the processing chamber; a branch flow control unit for controlling branch flows of the processing gas distributed from the processing gas supply line to the branch lines based on inner pressures of the branch lines; an additional gas supply unit for supplying an additional gas; and an additional gas supply line for allowing the additional gas to flow therein, wherein at least one of the gas introduction sections is divided into a processing gas introduction section for introducing the processing gas from the branch lines into the processing chamber and an additional gas introduction section for introducing the additional gas from the additional gas supply line to be added to the processing gas

In accordance with the present invention, desired in-surface uniformity can be achieved by supplying a gas from plural portions in a processing chamber with a simple line configuration and a simple control operation without being affected by a pressure variation and the like.

### BRIEF DESCRIPTION OF THE DRAWINGS

The above and other objects and features of the present invention will become apparent from the following description of preferred embodiments, given in conjunction with the accompanying drawings, in which:

FIG. 1 shows a cross sectional view of an exemplary configuration of a substrate processing apparatus in accordance with a first embodiment of the present invention;

FIG. 2 describes a transversal cross sectional view of an inner upper electrode in accordance with the first embodiment of the present invention;

FIG. 3 provides a block diagram of an exemplary configuration of a gas supply system in accordance with the first embodiment of the present invention;

FIG. 4 is a block diagram of an exemplary configuration of a control unit in accordance with the first embodiment of the present invention;

FIG. 5 offers a flowchart of an exemplary process of a substrate processing apparatus in accordance with the first embodiment of the present invention;

FIG. 6 presents a block diagram of another exemplary configuration of the gas supply system in accordance with the first embodiment of the present invention;

FIG. 7 illustrates a block diagram of an exemplary configuration of a gas supply system of a substrate processing apparatus in accordance with a second embodiment of the present invention;

FIG. 8 depicts a transversal cross sectional view of an inner upper electrode in accordance with the second embodiment of the present invention; and

FIG. 9 describes a block diagram of another exemplary configuration of the gas supply system in accordance with the second embodiment of the present invention.

### DETAILED DESCRIPTION OF THE EMBODIMENT

Hereinafter, embodiments of the present invention will be described in detail with reference to the accompanying drawings. Like reference numerals will be given to like parts having substantially the same functions, and redundant description thereof will be omitted in the specification and the accompanying drawings.

### Configuration Example of Substrate Processing Apparatus in Accordance with a First Embodiment

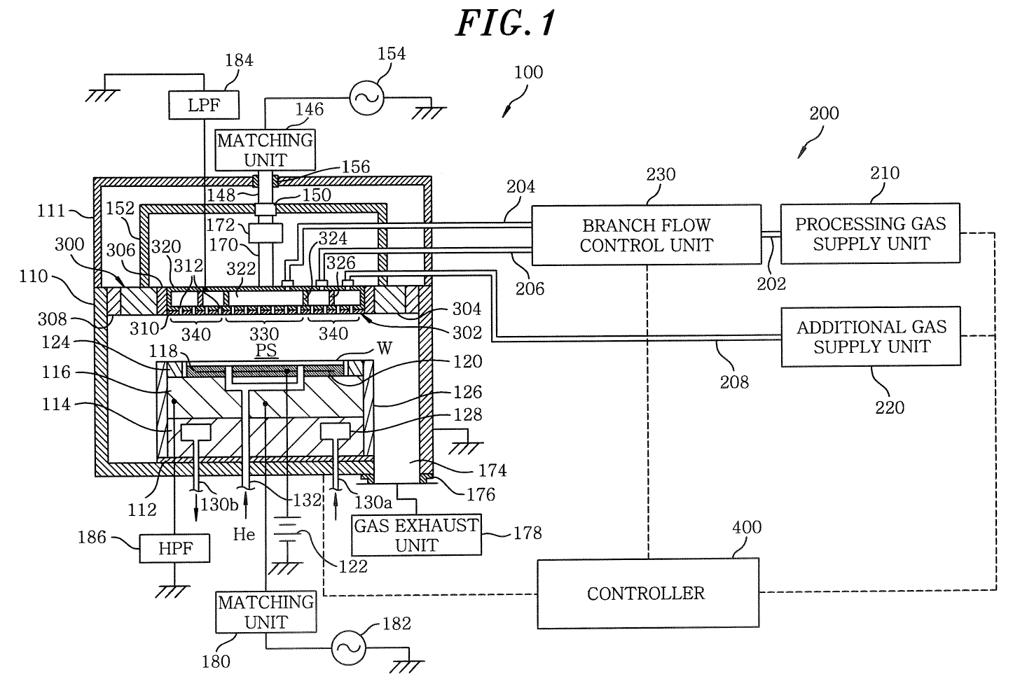

First of all, a substrate processing apparatus in accordance with a first embodiment of the present invention will be described with reference to FIG. 1. FIG. 1 is a cross sectional view showing a schematic configuration of the substrate processing apparatus in accordance with the first embodiment of the present invention. Herein, the substrate processing apparatus is configured as a parallel plate type plasma etching apparatus.

Such a substrate processing apparatus 100 includes a processing chamber 110 formed of a substantially cylindrical processing vessel. The processing vessel is made of aluminum alloy, for example, and is electrically grounded. Further, an inner wall surface of the processing vessel is coated with an alumina film or an yttrium oxide (Y₂O₃) film.

Disposed inside the processing chamber 110 is a susceptor 116 forming a lower electrode serving also as a mounting table for mounting thereon a wafer W as a substrate. To be specific, the susceptor 116 is supported on a cylindrical susceptor support 114 which is provided at a substantially central portion of an inner bottom surface of the processing chamber 110 with an insulating plate 112 disposed therebetween. The susceptor 116 is made of aluminum alloy, for example.

Provided on the susceptor 116 is an electrostatic chuck 118 for supporting the wafer W. The electrostatic chuck 118 has therein an electrode 120 that is electrically connected with a DC power supply 122. Accordingly, the electrostatic chuck 118 can attract and hold thereon the wafer W with the Coulomb force generated by a DC voltage applied from the DC power supply 122 to the electrode 120.

Moreover, a focus ring 124 is provided on top of the substrate 116 to surround the electrostatic chuck 118. Further, a cylindrical inner wall member 126 made of quartz, for example, is attached to outer peripheral surfaces of the susceptor 116 and the susceptor support 114.

A ring-shaped coolant chamber 128 is formed inside the susceptor support 114 to communicate with a chiller unit (not shown), for example, installed outside the processing chamber 110 via lines 130a and 130b. A coolant (liquid coolant or cooling water) is supplied to the coolant chamber 128 to be circulated therein via the lines 130a and 130b, so that a temperature of the wafer W on the susceptor 116 can be controlled.

A gas supply line 132 is extended through the susceptor 116 and the susceptor support 114 to the top surface of the electrostatic chuck 118. Accordingly, a thermally conductive gas (backside gas) such as He gas or the like can be supplied between the wafer W and the electrostatic chuck 118 through the gas supply line 132.

Provided above the susceptor 116 is an upper electrode 134 facing in parallel with the susceptor 116 forming the lower electrode. A plasma generation space PS is formed between the susceptor 116 and the upper electrode 134.

The upper electrode 300 includes a circular plate-shaped inner upper electrode 302 and a ring-shaped outer upper electrode 304 surrounding an outer portion of the inner upper electrode 302. The inner upper electrode 302 forms a shower head for injecting a gas toward the plasma generation space PS above the wafer W mounted on the susceptor 116. Further, the inner upper electrode 302 includes a circular electrode plate 310 having a plurality of gas injection openings 312 and an electrode support 320 for releasably holding a top surface of the electrode plate 310. The electrode support 320 is formed in a circular plate shape having a diameter substantially same as that of the electrode plate 310. An exemplary configuration of the shower head (the inner upper electrode 302) will be described later.

A ring-shaped dielectric material 306 is interposed between the inner upper electrode 302 and the outer upper electrode 304. Airtightly interposed between the outer upper electrode 304 and an inner peripheral wall of the processing chamber 110 is a ring-shaped insulating shield member 308 made of alumina, for example.

A first high frequency power supply 154 is electrically connected with the outer upper electrode 304 via a power feeder 152, a connector 150, an upper power supply rod 148 and a matching unit 146. The first high frequency power supply 154 can output a high frequency voltage having a frequency of 40 MHz or higher (e.g., 60 MHz).

The power feeder 152 is formed in a substantially cylindrical shape having an open bottom, for example, and has a lower portion connected with the outer upper electrode 304. A lower portion of the upper power supply rod 148 is electrically connected with an upper central portion of the power feeder 152 through the connector 150. An upper portion of the upper power supply rod 148 is connected with an output side of the matching unit 146. The matching unit 146 is connected with the first high frequency power supply 154 and thus can match an internal impedance of the first high frequency power supply 154 to a load impedance.

An exterior of the power feeder 152 is surrounded by a cylindrical ground conductor 111 having a sidewall of a diameter substantially same as that of the processing chamber 110. A lower portion of the ground conductor 111 is connected with an upper portion of the sidewall of the processing chamber 110. The aforementioned upper power supply rod 148 penetrates through an upper central portion of the ground conductor 111. An insulation member 156 is interposed at a contact portion between the ground conductor 111 and the upper power supply rod 148.

(Exemplary Configuration of Shower Head)

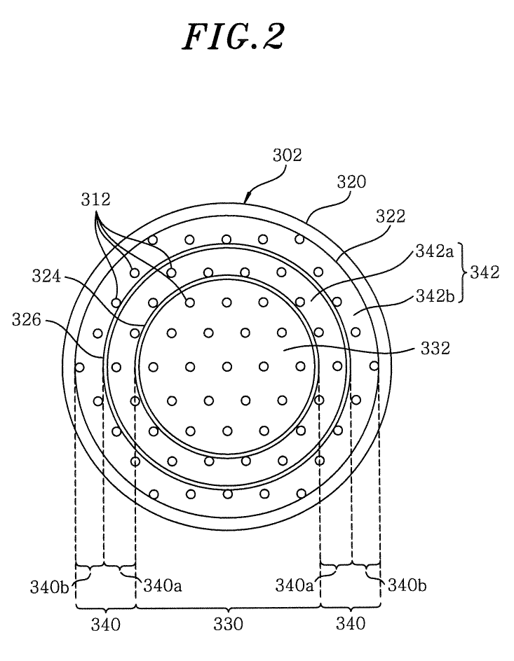

Hereinafter, a specific exemplary configuration of the inner upper electrode 302 forming the shower head will be described in detail with reference to FIGS. 1 and 2. FIG. 2 shows a transversal cross sectional view of the inner upper electrode 302. Referring to FIG. 2, there is illustrated an exemplary configuration of the inner upper electrode 302 used when introducing a gas from different portions in the processing chamber 110, e.g., from a first and a second gas introduction section 330 and 340, toward a first and a second region on the surface of the wafer W mounted on the susceptor 116. For example, the first region is a central region of the wafer W (hereinafter, referred to as “central region”), and the second region is a peripheral region surrounding the central region (hereinafter, referred to as “edge region”).

The second gas introduction section 340 is divided into a processing gas introduction section 340a for introducing a processing gas from a processing gas supply unit 210 to be described later into the processing chamber 110 and an additional gas introduction section 340b for introducing an additional gas from an additional gas supply unit 220 into the processing chamber 110 to be added to the processing gas.

The following is a description of configurations of the first and the second gas introduction section 330 and 340. The electrode support 320 has therein a buffer chamber 322 formed in a circular-shaped space. The buffer chamber 322 is partitioned by a first ring-shaped partition wall member 324 into a first buffer chamber 332 formed in a circular-shaped space and a second buffer chamber 342 formed in a ring-shaped space surrounding the first buffer chamber 322. The second buffer chamber 342 is partitioned by a second ring-shaped partition wall member 326 into a processing gas buffer chamber 342a formed at the inner side in a ring-shaped space and an additional gas buffer chamber 342b formed at the outer side in a ring-shaped space.

The first gas introduction section 330 includes the first buffer chamber 332 and a plurality of gas injection openings 312 provided in a bottom surface thereof, and the second gas introduction section 340 includes the second buffer chamber 342 and a plurality of gas injection openings 312 provided in a bottom surface thereof. The processing gas introduction section 340a of the second gas introduction section 340 includes the processing gas buffer chamber 342a and a plurality of gas injection openings 312 provided in a bottom surface thereof, and the additional gas introduction section 340b includes the additional gas buffer chamber 342b and a plurality of gas injection openings 312 provided in a bottom surface thereof. The first and the second ring-shaped partition wall member 324 and 326 are formed of O-rings, for example.

The gas supply system 200 supplies a gas to the buffer chamber 332 and 342. The preset gas is injected from the first and the second gas introduction section 330 and 340 toward the central and the edge region on the wafer W via the first and the second buffer chamber 332 and 342, respectively.

As shown in FIG. 1, a lower power feeder 170 is electrically connected with a top surface of the electrode support 162. The lower power feeder 170 is connected with the upper power supply rod 148 via the connector 150. A variable condenser 172 is provided in the lower power feeder 170. By adjusting an electrostatic capacitance of the variable condenser 172, it is possible to adjust a comparative ratio between an intensity of an electric field formed right under the outer upper electrode 304 and that of an electric field formed right under the inner upper electrode 302, the electric fields being formed by the high frequency voltage applied from the first high frequency power supply 154.

A gas exhaust port 174 is formed at a bottom portion of the processing chamber 110 and connected via a gas exhaust line 176 with a gas exhaust unit 178 having a vacuum pump and the like. By exhausting an inside of the processing chamber 110 with the use of the gas exhaust unit 178, the inside of the processing chamber 110 can be depressurized to a desired vacuum level.

A second high frequency power supply 182 is electrically connected with the susceptor 116 via a matching unit 180. The second high frequency power supply 182 can output a high frequency voltage having a frequency between 2 MHz and 20 MHz, e.g., a frequency of 2 MHz.

A low pass filter 184 is electrically connected with the inner upper electrode 138 of the upper electrode 134. The low pass filter 184 blocks the high frequency power from the first high frequency power supply 154 and passes the high frequency from the second high frequency power supply 182 to the ground. Meanwhile, a high pass filter 186 is electrically connected with the susceptor 116 forming the lower electrode. The high pass filter 186 passes the high frequency power from the first high frequency power supply 154 to the ground.

(Gas Supply System)

Hereinafter, the gas supply system 200 will be described with reference to FIG. 1. Referring to FIG. 1, there is shown an example in which the processing gases are classified into a first processing gas (processing gas for the central portion) to be supplied toward the central portion of the wafer W and a second processing gas (processing gas for the edge portion) to be supplied toward the edge portion of the wafer W. However, the processing gases may be classified into three or more types without being limited to the above.

As shown in FIG. 1, the gas supply system 200 includes a processing gas supply unit 210 for supplying a processing gas for performing on a wafer a specific process such as a film formation process, an etching process or the like and an additional gas supply unit 220 for supplying an additional gas. The processing gas supply unit 210 is connected with a processing gas supply line 202 forming a processing gas feed passage, and the additional gas supply unit 220 is connected with an additional gas supply line 208 forming an additional gas feed passage. The processing gas supply line 202 is branched into a first branch line 204 forming a first branch path and a second branch line 206 forming a second branch path. Further, the first and the second branch line 204 and 206 may branch off at an inside or outside of a branch flow control unit 230.

The gas supply system 200 includes the branch flow control unit (e.g., flow splitter) 230 for controlling respective branch flows of the first and the second processing gas flowing in the first and the second processing branch line 254 and 256 based on respective pressures in the first and the second branch line 254 and 256.

The first and the second branch line 204 and 206 are respectively connected with the first and the second gas introduction section 330 and 340 of the inner upper electrode 302. Specifically, the first branch line 204 is connected with the first buffer chamber 332 of the first gas introduction section 330. Further, the second branch line 206 is connected with the processing buffer chamber 342a of the processing gas introduction section 340a of the second gas introduction section 340. Moreover, the additional gas supply line 208 is connected with the additional gas buffer chamber 342b of the additional gas introduction section 340b.

The gas supply system 200 distributes the processing gases from the processing gas supply unit 210 into the first and the second processing gas branch line 254 and 256 while controlling branch flows thereof with the use of the branch flow control unit 230. The first processing gas flowing in the first branch line 254 is supplied toward the central portion of the wafer W via the first buffer chamber 163a, whereas the second processing gas flowing in the second branch line 256 is supplied toward the edge portion of the wafer W via the second buffer chamber 163b.

When the additional gas is supplied from the additional gas supply unit 220, the additional gas is introduced from the additional gas introduction section 340b of the second gas introduction section 340 via the additional gas supply line 208. Next, the additional gas from the additional gas introduction section 340b is mixed with the second processing gas from the second gas introduction section 340 in the processing chamber 110 and then supplied together with the second processing gas toward the edge region on the wafer W.

(Specific Configuration Example of Gas Supply System)

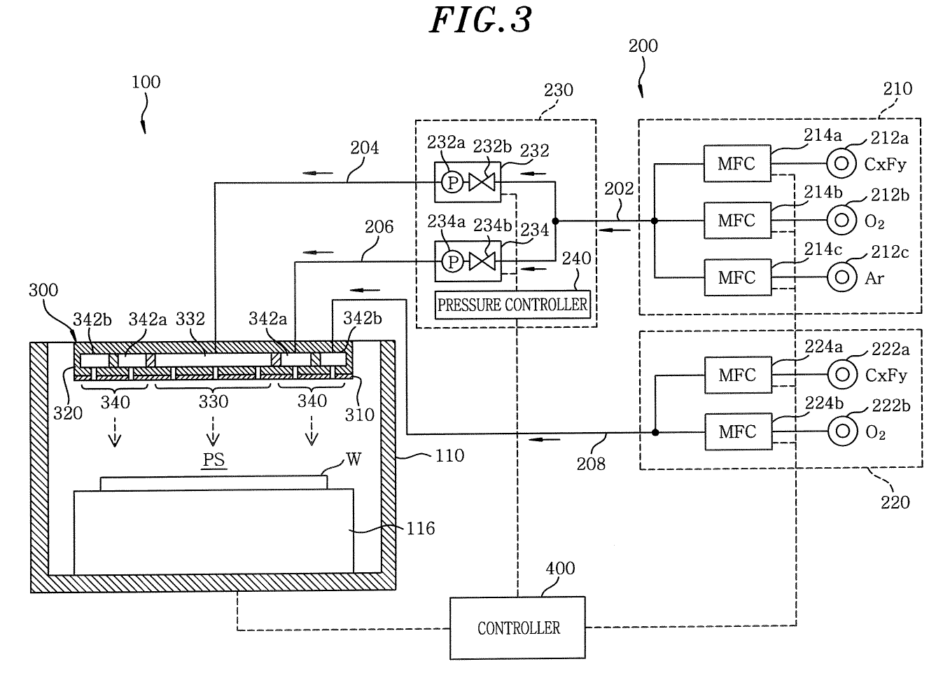

The following is a detailed description on a configuration example of each unit of the gas supply system 200. FIG. 3 is a block diagram illustrating a specific configuration example of the gas supply system 200. As shown in FIG. 3, the processing gas supply unit 210 includes a gas box accommodating therein a plurality of (e.g., three) gas supply sources 212a, 212b and 212c. Lines of the gas supply sources 212a to 212c are connected with the processing gas supply line 252 where gases from the gas supply sources 212a to 212c are joined. Provided on the lines of the gas supply sources 212a to 212c are mass flow controllers 214a to 214c for adjusting respective flow rates of the gases therefrom. The gases from the gas supply sources 212a to 212c of the processing gas supply unit 210 are mixed at a preset flow rate ratio. Next, the mixed gas flows along the processing gas supply line 252 and then is distributed into the first and the second branch line 254 and 256.

As shown in FIG. 3, the gas supply source 212a airtightly seals therein, e.g., a C_{X}F_{Y} gas (a fluorocarbon-based fluorine compound such as CF₄, C₄F₆, C₄F₈, C₅F₈ or the like) as an etching gas; the gas supply source 212b airtightly seals therein, e.g., O₂ gas as a gas for controlling a deposition of CF-based reaction products; and the gas supply source 212c airtightly seals therein, e.g., Ar gas as a rare gas serving as a carrier gas. The number of gas supply sources of the processing gas supply unit 210 may be one, two or four or more without being limited to the example shown in FIG. 3.

As exemplarily shown in FIG. 3, the additional gas supply unit 220 includes a gas box accommodating therein a plurality of (e.g., two) gas supply sources 222a and 222b. Lines of the gas supply sources 222a and 222b are connected with the additional gas supply line 272 where gases from the gas supply sources 222a and 222b are joined. Provided on the lines of the gas supply sources 222a and 222b are mass flow controllers 224a and 224b for adjusting respective flow rates of the gases therefrom. One of the gases from the gas supply sources 222a and 222b of the additional gas supply unit 220 is selected or both of them are mixed at a preset flow rate ratio. Next, the selected or the mixed gas flows along the additional gas supply line 272.

The gas supply source 222a airtightly seals therein a C_{X}F_{Y} gas capable of facilitating an etching, for example. The gas supply source 222b airtightly seals therein O₂ gas capable of controlling a deposition of CF-based reaction products, for example. The number of gas supply sources of the additional gas supply unit 220 may be one or three or more without being limited to the example shown in FIG. 3.

The branch flow control unit 230 includes a pressure control unit 232 for controlling a pressure in the first processing gas branch line 254 and a pressure control unit 234 for controlling a pressure in the second processing gas branch line 256. To be specific, the pressure control unit 232 has a pressure sensor 232a for detecting the pressure in the first processing gas branch line 254 and a valve 232b for controlling an opening degree of the first processing gas branch line 254. The pressure controller 234 has a pressure sensor 234a for detecting the pressure in the second processing gas branch line 256 and a valve 234b for controlling an opening degree of the second processing gas branch line 256.

The pressure control units 232 and 234 are connected with a pressure controller 240 for controlling, in accordance with instructions from the controller 400, opening degrees of the valves 232b and 234b based on the pressures detected by the pressure sensors 232a and 234a, respectively. The controller 400 controls the branch flow control unit 230 by regulating a pressure ratio, for example. In such a case, the pressure controller 240 controls respective opening degrees of the valves 232b and 234b to achieve a target flow rate ratio between the first and the second processing gas in accordance with instructions from the controller 400, i.e., a target pressure ratio of the pressures in the first and the second processing gas branch line 254 and 256. The pressure controller 240 may be built in the branch flow control unit 230, as a control board, or may be provided separately from the branch flow control unit 230. Further, the pressure controller 240 may be provided inside the controller 400.

The controller 400 may be configured to perform the control of the processing gas supply unit 210 and the additional gas supply unit 220 of the gas supply system 200, and the control of the first high frequency power supply 154, the second high frequency power supply 182 and the like, in addition to the control of the branch flow control unit 230.

(Configuration Example of Controller)

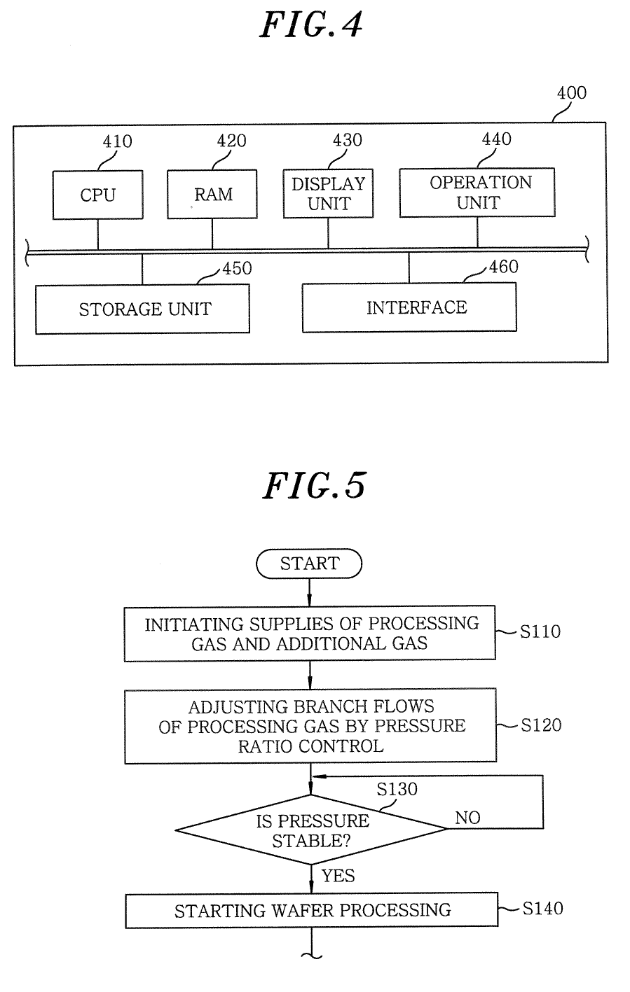

Hereinafter, the configuration example of the controller 400 will be described with the drawings. FIG. 4 provides a block diagram showing a configuration example of the controller 400. As shown in FIG. 4, the controller 400 includes a CPU (central processing unit) 410 forming a controller main body; a RAN (random access memory) 420 having a memory area used for various data processing performed by the CPU 410; a display unit 430 formed of a liquid crystal display and the like for displaying a operation screen, a selection screen and the like; a operation unit 440 containing a touch panel and the like for allowing an operator to input or edit various data such as process recipes and the like and to output various data such as the process recipes or process logs to a specific storage medium; a storage unit 450; and an interface 460.

The storage unit 450 stores therein, e.g., processing programs for performing various processes of the substrate processing apparatus 100, information (data) required for executing the processing programs and the like. Such a storage unit 450 includes, e.g., a memory, an HDD (hard disk drive) and the like. The CPU 410 reads the program data and the like on demand and executes various processing programs. For example, the CPU 410 controls the gas supply system 200 to perform a gas supply process for supplying a specific gas into the processing chamber 110 before processing the wafer.

The interface 460 is connected with each unit controlled by the CPU 410, such as the branch flow control unit 230, the processing gas supply unit 210, the additional gas supply unit 220 and the like. The interface 460 includes a plurality of I/O ports and the like, for example.

The CPU 410, the RAM 420, the display unit 430, the operation unit 440, the storage unit 450, and the interface 460 are connected with each other by bus lines such as a control bus, a data bus and the like.

(Process of Substrate Processing Apparatus)

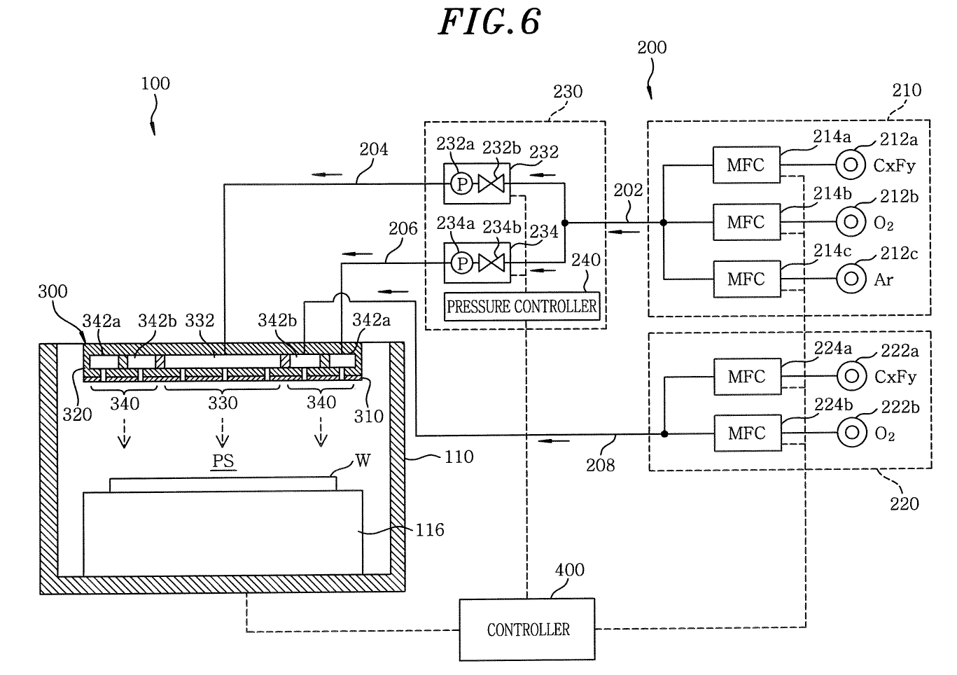

The following is a description of a process performed based on a specific program by the control unit 400 in the substrate processing apparatus 100. The control unit 400 controls the gas supply system 200 to perform a gas supply process for supplying a gas into the processing chamber 110 before performing, e.g., an etching process on the wafer. FIG. 5 shows a specific example of the gas supply process.

In step S110, the control unit 400 controls the processing gas supply unit 210 and the additional gas supply unit 220 to initiate supplies of a processing gas and an additional gas, respectively. Once the supply of the processing gas is initiated, a preset gas in the processing gas supply unit 210 flows at a specified flow rate toward the processing gas supply line 202. Further, once the supply of the additional gas is initiated, a preset gas in the additional gas supply unit 220 flows at a specified flow rate toward the additional gas supply line 208.

For example, in case CₓF_{y} gas, O₂ gas and Ar gas are respectively supplied at specified flow rates from the gas supply sources 212a to 212c of the processing gas supply unit 210, they are mixed at a preset mixing ratio and a gaseous mixture of CₓF_{y} gas, O₂ gas and Ar gas flows as a processing gas through the processing gas supply line 202. Moreover, in case a CₓF_{y} gas (e.g., CF₄ gas) capable of facilitating an etching, for example, is supplied at a specified flow rate from the gas supply source 222 of the additional gas supply unit 220, it flows through the additional gas supply line 208.

In step S120, the control unit 400 controls the branch flow control unit 230 to adjust branch flows of the processing gas by controlling a pressure ratio. To be specific, when the control unit 400 receives an instruction for controlling a pressure ratio, the branch flow control unit 230 adjusts opening degrees of the valves 232b and 234b by using a pressure controller 240 based on pressures measured by pressure sensors 232a, 234a, thereby controlling a ratio of pressures in the first and the second branch line 204 and 206 to a target pressure ratio. Accordingly, a flow rate ratio of the first and the second processing gas is determined, the first and the second processing gas being supplied to the first and the second buffer chamber 332 and 342 via the first and the second branch line 204 and 206, respectively.

When the supply of each gas is initiated, the processing gas from the processing gas supply line 202 is distributed to the first and the second branch line 204 and 206. Next, the processing gas is supplied to the first buffer chamber 332 and the processing gas buffer chamber 342a of the second buffer chamber 342 and then injected into the processing chamber 110. Accordingly, the processing gas from the first buffer chamber 332 is supplied toward the central region of the wafer W on the susceptor 116, while the processing gas from the processing gas buffer chamber 342a is mixed with the additional gas from the additional gas buffer chamber 342b and then supplied toward the edge region of the wafer W.

Next, it is checked in step S130 whether or not the pressures in the first and the second branch line 204 and 206 are stable. If it is determined that the inner pressures thereof are stable, the wafer is processed in step S140. By such a gas supply process, under the depressurized atmosphere in the processing chamber 110, the processing gas of a specified flow rate ratio is supplied toward the central region of the wafer W and, also, a gaseous mixture of the processing gas of the specified flow rate ratio and the additional gas, e.g., a processing gas containing a large amount of CF₄ gas, is supplied toward the edge region of the wafer W. Accordingly, etching characteristics on the edge region of the wafer W can be adjusted relatively to those on the central region of the wafer W, which results in uniform etching characteristics in the surface of the wafer W.

In accordance with the gas supply system 200 of this embodiment, the processing gas from the processing gas supply unit 210 is distributed to the first and the second branch line 204 and 206 and, then, the processing gas from the first branch line 204 is supplied toward the central region of the wafer W while maintaining the flow rate ratio thereof in the processing gas supply unit 210, whereas the processing gas from the second branch line 206 is supplied toward the edge region of the wafer W after its components and flow rate are adjusted by adding the additional gas thereto. In this way, the processing gas supply unit 210 supplies a processing gas having common components to both the branch lines 254 and 256, and the components and the flow rate of the processing gas flowing in the second branch line 206 are adjusted by adding thereto an additional gas as desired. Thus, when the number of common components in the processing gas distributed to the branch lines is increased, the number of lines can be reduced compared with a case where each branch line is provided with processing gas supply sources. By minimizing the number of lines of the gas supply system 200, the gas supply system 200 can be configured with a simple line configuration. Further, since the branch flows of the processing gas are adjusted based on the pressures in the branch lines 204 and 206, the gas can be supplied from plural portions in the processing chamber 110 with a simple control operation.

The additional gas to be added to the second processing gas supplied via the second branch line 206 is supplied from the additional gas introduction section 340b into the processing chamber 110 via the additional gas supply line 208 of a different system from the second branch line 206, so that the pressures in the first and the second branch line 204 and 206 are not affected thereby. Hence, a flow rate ratio (distribution ratio) of the first and the second processing gas flowing in the first and the second branch line 204 and 206 is not changed between before and after the additional gas is supplied, which accomplishes desired in-surface uniformity.

If the additional gas supply, for supplying the additional gas to the second processing gas, joins the second branch line 206 at a downstream side of the branch flow control unit 230, the pressure in the second branch line is varied due to the supply of the additional gas, which would lead to a variation in the flow rate ratio of the first and the second processing gas adjusted by the branch flow control unit between before and after the additional gas is supplied. To that end, the additional gas needs to be supplied when the pressure becomes stable after initiating the supply of the processing gas, or an additional control is required to prevent the flow rate ratio of the first and the second processing gas from being changed between before and after the additional gas is supplied. However, the additional control lengthens the gas supply process time and the wafer processing time, thereby deteriorating the throughput.

In contrast, in accordance with the gas supply system 200 of this embodiment, since the additional gas can be supplied into the processing chamber 110 without affecting the pressures in the first and the second branch line 204 and 206, the additional gas can be supplied either before or after the supply of the processing gas, or simultaneously supplied together with the processing gas. Accordingly, it is unnecessary to perform the control for preventing the flow rate ratio of the first and the second processing gas from being changed between before and after the additional gas is supplied. As a result, a simpler control operation and a shortened gas supply process time can be accomplished, thereby preventing deterioration of the throughput.

Further, in accordance with the gas supply system 200 of this embodiment, the additional gas is supplied from the additional gas supply line 208 into the processing chamber 110 via the additional gas introduction section 340b of a low pressure, so that the additional gas can easily flow and reach the processing chamber in a short period of time compared with a case where the additional gas is supplied to the second branch line 206 whose inside pressure is high due to the processing gas flowing therein. Further, due to the low pressure area to which the additional gas is supplied, even when a flow rate of the additional gas is very small, the additional gas can reach the processing chamber in a short period of time compared with the case where the additional gas is supplied to the high pressure second branch line 206.

When the additional gas is supplied, it may be supplied at an initial flow rate greater than a preset flow rate and then at the preset flow rate after a specific period of time (e.g., a few seconds). In this way, even when the preset flow rate of the additional gas is very small, the pressure in the additional gas supply line can be rapidly increased, so that the additional gas can be supplied into the processing chamber in a short period of time, thereby further improving the throughput. In this case, an interlock control of the additional gas may not be performed for the specific time period while the additional gas is supplied at the initial flow rate and may be performed while the additional gas is supplied at the preset flow rate. The interlock control of the additional gas includes, for example, a control for monitoring whether or not a pressure of the additional gas exceeds a predetermined level within a specific period of time and then performing an error process such as a notification thereof at a time when it is determined that the pressure exceeds the predetermined level.

When the additional gas supply line is configured to supply the additional gas to the middle of the second branch line 206, if a flow rate of the additional gas is large, the additional gas may flow into the branch flow control unit 230 due to a diffusion thereof. Therefore, an allowable flow rate of the additional gas needs to be restricted to a level at which the additional gas is prevented from flowing into the branch flow control unit 230. On the other hand, in accordance with the gas supply system 200 of this embodiment, the additional gas is supplied from the additional gas introduction section 340b to the processing chamber 110 via the additional gas supply line 208 of a different system from the second branch line 206, so that the additional gas would not flow into the branch flow control unit 230 due to the diffusion thereof. Hence, the flow rate of the additional gas does not need to be restricted, and the additional gas can be supplied at a desired flow rate.

In the gas supply system of this embodiment, the processing gas and the additional gas are supplied into the processing chamber 110 via different lines of systems. Thus, when a flow rate or a flow rate ratio of the additional gas is adjusted, it is unnecessary to adjust the processing gas, which makes it easy to control the additional gas.

With the gas supply system 200 shown in FIG. 3, in the first and the second gas introduction section 330 and 340, the additional gas introduction section 340b of the second gas introduction section 340 is disposed at the outermost side, so that the additional gas may be injected from the additional gas introduction section 340b to surround the plasma generation space PS depending on a flow rate thereof. This makes it possible to confine a plasma and hence to stabilize plasma characteristics.

Further, in the gas supply system 200 of FIG. 3, the second buffer chamber 342 is partitioned into two spaces by the second ring-shaped partition wall member 326, the inner and the outer space being respectively defined as the processing gas buffer chamber 342a and the additional gas buffer chamber 342b; and, therefore, the inner and the outer side of the second gas introduction section 340 are defined as the processing gas introduction section 340a and the additional gas introduction section 340b, respectively. However, the configuration of the gas supply system 200 is not limited to that shown in FIG. 3.

For example, as shown in FIG. 6, a gas supply system 200 may have a configuration in which the second buffer chamber 342 is partitioned into two spaces by the second ring-shaped partition wall member 326, the inner and the outer space being respectively defined as the additional gas buffer chamber 342b and the processing gas buffer chamber 342a; and, therefore, the inner and the outer side of the second gas introduction section 340 are defined as the additional gas introduction section 340b and the processing gas introduction section 340a, respectively. In such a case, the second branch line 206 is connected with the outer processing gas introduction section 340a, and the additional gas supply line 208 is connected with the inner additional gas introduction section 340b.

In the gas supply system 200 of FIG. 6, as similar to the gas supply system 200 of FIG. 3, a processing gas of a specified flow rate ratio is supplied toward the central region of the wafer W and a gaseous mixture of the processing gas of the specified flow rate ratio and the additional gas is supplied toward the edge region of the wafer W. Hence, etching characteristics on the edge region of the wafer W can be adjusted relatively to those on the central region of the wafer W, which results in uniform etching characteristics in the surface of the wafer W.

Also with the line configuration of the gas supply system of FIG. 6, the additional gas is directly supplied from the additional gas introduction section 340b into the processing chamber 110 via the additional gas supply line 208, so that the pressures in the first and the second branch line 204 and 206 are not affected thereby. Therefore, the flow rate ratio (distribution ratio) of the first and the second processing gas flowing in the first and the second branch line 204 and 206 is not changed between before and after the additional gas is supplied, which accomplishes desired in-surface uniformity.

Besides, there may be exemplified a case where the second buffer chamber 342 is partitioned into three spaces by two ring-shaped partition wall members 326 having different diameters, wherein the inner and the outer space are defined as the processing gas buffer chamber 342a and the intermediate space therebetween is defined as the additional gas buffer chamber 342b; and, therefore, the inner and the outer side of the second gas introduction section 340 may be defined as the processing gas introduction section 340a while the intermediate side thereof is defined as the additional gas introduction section 340b.

### Exemplary Configuration of Substrate Processing Apparatus in Accordance with Second Embodiment

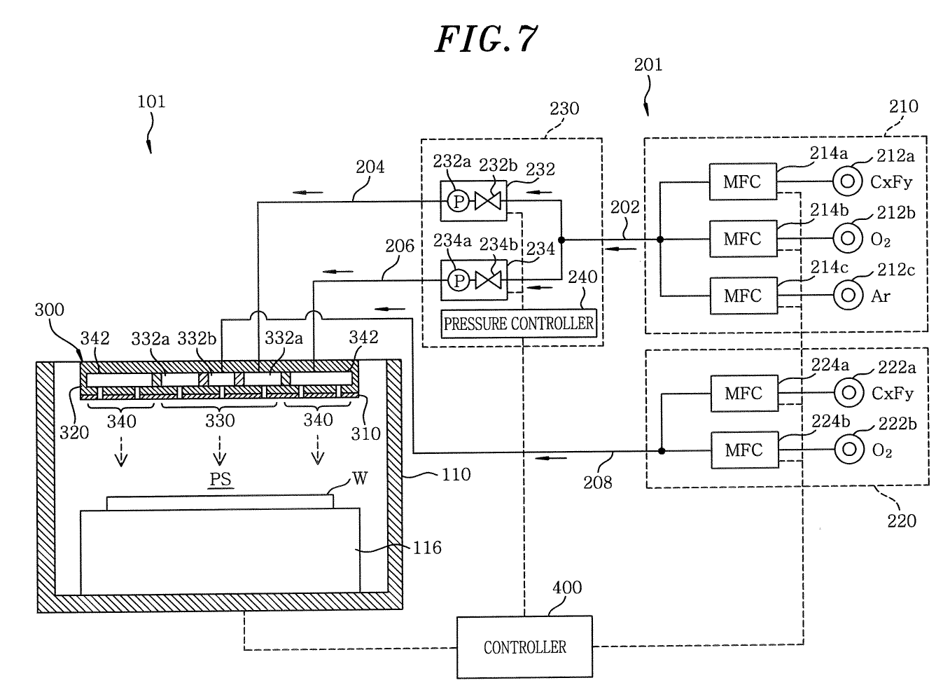

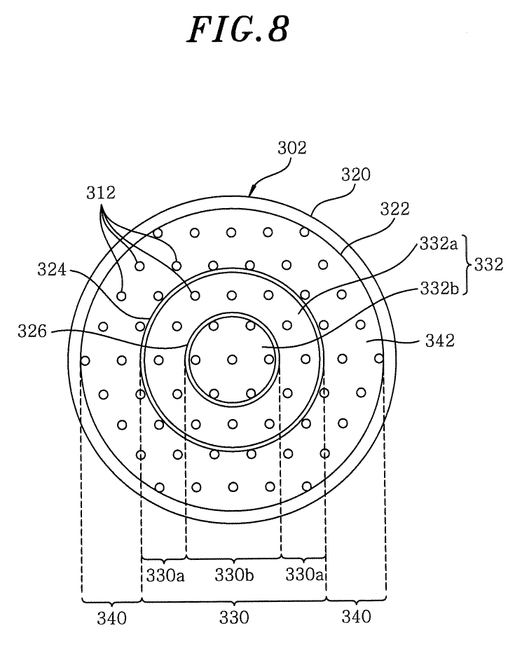

Hereinafter, a substrate processing apparatus 101 in accordance with a second embodiment of the present invention will be described with reference to drawings. FIG. 7 provides a block diagram of an exemplary configuration of the gas supply system 201 of the substrate processing apparatus 101 in accordance with the second embodiment of the present invention. FIG. 8 depicts a transversal cross sectional view of the inner upper electrode 302 forming the shower head in accordance with this embodiment.

Although, in the first embodiment, the second gas introduction section 340 for supplying a gas toward the edge region of the wafer W is divided into the processing gas introduction section 340a and the additional gas introduction section 340b, the second embodiment has a configuration in which the first gas introduction section 330 for supplying a gas toward the central region of the wafer W is divided into a processing gas introduction section 330a and an additional gas introduction section 330b, as shown in FIGS. 7 and 8.

As illustrated in FIG. 8, the inner upper electrode 302 in accordance with this embodiment is partitioned by a first ring-shaped partition wall member 324 into a first buffer chamber 332 and a second buffer chamber 342. The first buffer chamber 332 is partitioned by a second ring-shaped partition wall member 326 into an additional gas buffer chamber 332b formed at the inner side in a circular-shaped space and a processing gas buffer chamber 332a formed at the outer side in a ring-shaped space. The processing gas introduction section 330a of the first gas introduction section 330 includes the processing gas buffer chamber 332a and a plurality of gas injection openings 312 provided in a bottom surface thereof, and the additional gas introduction section 330b includes the additional gas buffer chamber 332b and a plurality of gas injection openings 312 provided in a bottom surface thereof.

The processing gas introduction section 330a of the first gas introduction section 330 is connected with the first branch line 204. Further, the additional gas supply line 208 is connected with the additional gas introduction section 330b. Moreover, the second branch line 206 is connected with the second gas introduction section 340.

The gas supply process described in FIG. 5 can also be performed by the gas supply system 201 configured as described above. That is, the supplies of the processing gas and the additional gas are initiated in step S110 and, then, the branch flow control unit 230 adjusts, in step S120, branch flows of the processing gas by controlling a pressure ratio.

When the supply of each gas is initiated, the processing gas from the processing gas supply line 202 is distributed to the first and the second branch line 204 and 206. Next, the processing gas is supplied to the processing gas buffer chamber 332a of the first buffer chamber 332 and the second buffer chamber 342 and then injected into the processing chamber 110. Meanwhile, the additional gas from the additional gas supply line 208 is supplied to the additional gas buffer chamber 332b of the first buffer chamber 332 and then injected into the processing chamber 110. Accordingly, the processing gas from the first buffer chamber 332 is mixed with the additional gas from the additional gas buffer chamber 332b and then supplied toward the central region of the wafer W on the susceptor 116, while the processing gas from the second buffer chamber 342 is supplied toward the edge region of the wafer W.

Next, it is checked in step S130 whether or not the pressures in the first and the second branch line 204 and 206 are stable. If it is determined that the inner pressures thereof are stable, the wafer is processed in step S140. By such a gas supply process, under the depressurized atmosphere in the processing chamber 110, a gaseous mixture of the processing gas of the specified flow rate ratio and the additional gas, e.g., a processing gas containing a large amount of CF₄ gas, is supplied toward the central region of the wafer W and, also, the processing gas of the specified flow rate ratio is supplied toward the edge region of the wafer W. Hence, etching characteristics on the edge region of the wafer W can be adjusted relatively to those on the central region of the wafer W, which results in uniform etching characteristics on the surface of the wafer W.

In the gas supply system 201 in accordance with the second embodiment, the additional gas to be added to the first processing gas supplied via the second branch line 206 is supplied from the additional gas introduction section 330b into the processing chamber 110 via the additional gas supply line 208 of a different system from the second branch line 206, so that the pressures in the first and the second branch line 204 and 206 are not affected thereby. For this reason, the flow rate ratio (distribution ratio) of the first and the second processing gas flowing in the first and the second branch line 204 and 206 is not changed between before and after the additional gas is supplied, which accomplishes desired in-surface uniformity.

Since the additional gas and the processing gas can be supplied simultaneously, it is unnecessary to perform the control for preventing the flow rate ratio of the first and the second processing gas from being changed between before and after the additional gas is supplied. As a result, the control can be achieved in a simpler manner and the time required for the gas supply process can be significantly shortened, thereby preventing deterioration of the throughput.

In the gas supply system 201 of FIG. 7, the first buffer chamber 332 is partitioned into two spaces by the second ring-shaped partition wall member 326, then inner and the outer space being respectively defined as the additional gas buffer chamber 332b and the processing gas buffer chamber 332a. Accordingly, the inner and the outer side of the first gas introduction section 330 are defined as the additional gas introduction section 330b and the processing gas introduction section 330a, respectively. However, the configuration of the gas supply system 201 is not limited to that shown in FIG. 7.

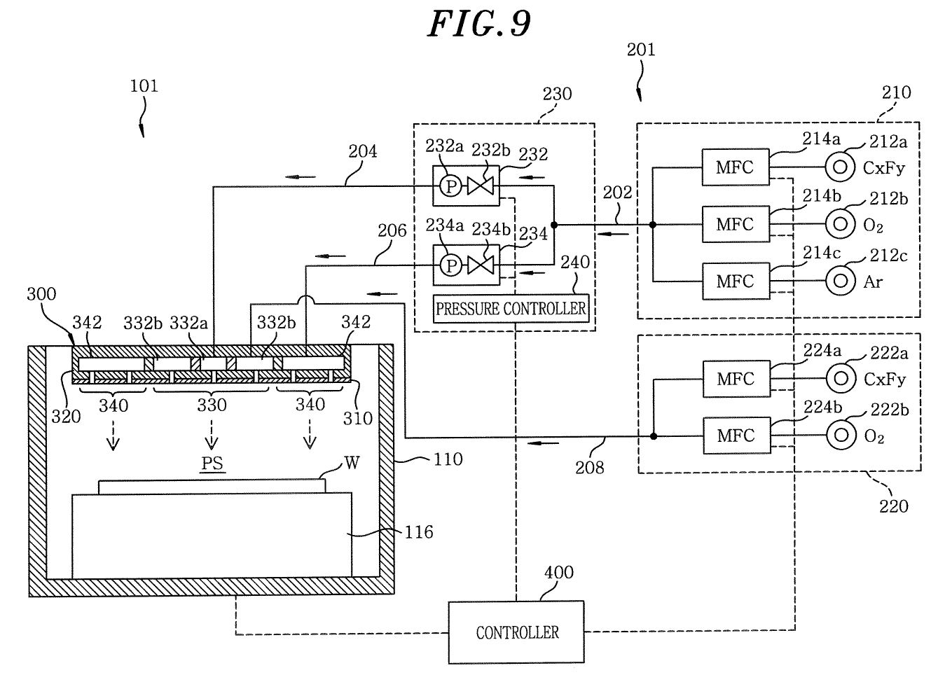

For example, as in the gas supply system 201 shown in FIG. 9, in the first buffer chamber 332 partitioned by the second ring-shaped partition wall member 326, the inner and the outer space may be respectively defined as the processing gas buffer chamber 332a and as the additional gas buffer chamber 332b and, therefore, the inner and the outer side of the first gas introduction section 330 may be defined as the processing gas introduction section 330a and the additional gas introduction section 330b, respectively. In this case, the first branch line 204 is connected with the inner processing gas introduction section 330a, and the additional gas supply line 208 is connected with the outer additional gas introduction section 330b.

Also with such a configuration, a gaseous mixture of a processing gas of a specified flow rate ratio and an additional gas is supplied toward the central region of the wafer W and, also, the processing gas of the specified flow rate ratio is supplied toward the edge region of the wafer W. Hence, etching characteristics on the edge region of the wafer W can be adjusted relatively to those on the central region of the wafer W, which results in uniform etching characteristics on the surface of the wafer W.

Also in the gas supply system 201 of FIG. 9, as similar to the gas supply system 201 of FIG. 7, the additional gas is supplied from the additional gas introduction section 330b into the processing chamber 110 via the additional gas supply line 208, so that the inner pressures of the first and the second branch line 204 and 206 are not affected thereby. Hence, the flow rate ratio (distribution ratio) of the first and the second processing gas flowing in the first and the second branch line 204 and 206 is not changed between before and after the additional gas is supplied, which leads to in-surface uniformity.

Besides, there may be exemplified a case where the first buffer chamber 332 is partitioned into three spaces by two ring-shaped partition wall members 326 having different diameters, wherein the inner space formed in a circular-shaped space and the outer space formed in a ring-shaped space are defined as the processing gas buffer chamber 332a and the intermediate space therebetween is defined as the additional gas buffer chamber 332b. Accordingly, the inner and the outer side of the first gas introduction section 330 are defined as the processing gas introduction section 330a, while the intermediate side thereof is defined as the additional gas introduction section 330b.

Although the processing gas from the processing gas supply unit 210 in the first and the second embodiment is distributed from the processing gas supply line 202 to the first and the second branch line 204 and 206 respectively connected with the first and the second gas introduction section 330 and 340, the processing gas may be distributed from the processing gas supply line 202 to three or more branch lines respectively connected with three or more gas introduction sections.

In other words, if the number of the branch lines is n, a first to an n-th branch line branch off from the processing gas supply line 202, the branch lines being respectively connected with a first to an n-th gas introduction section for introducing a gas from different portions in the processing chamber. At this time, the branch flow control unit 230 adjusts branch flows of the processing gas distributed from the processing gas supply line 202 to the first to the n-th branch line based on pressures in the first to the n-th branch line. At least one of the first to the n-th processing gas introduction section is divided into the processing gas introduction section for introducing the processing gas from the branch lines to the processing chamber and the additional gas introduction section for introducing the additional gas from the additional gas supply line to the processing chamber. In this way, by dividing the area on the wafer W into a first to an n-th region and introducing the gases from the first to the n-th gas introduction section to the first toward the n-th region above the wafer W, respectively, in-surface uniformity can be more precisely controlled.

While the invention has been shown and described with respect to the preferred embodiments, it will be understood by those skilled in the art that various changes and modification may be made without departing from the scope of the invention as defined in the following claims.

For example, in the aforementioned embodiments, there has been describe the case where the pressure controller controls branch flows of the processing gas flowing through the processing gas branch lines, but the present invention is not limited thereto. The branch flows of the processing gas flowing through the processing gas branch lines may be controlled by using respective mass flow controllers. Further, although the present invention is applied to a plasma etching apparatus as a substrate processing apparatus in the aforementioned embodiments, the present invention may be applied to another substrate processing apparatus to which a processing gas is supplied, e.g., a film forming apparatus such as a plasma CVD apparatus, a sputtering apparatus, a thermal oxidation apparatus or the like. Moreover, the present invention may be applied to a MEMS (micro electromechanical system) manufacturing apparatus or another substrate processing apparatus for processing as a target substrate an FPD (flat panel display), a photomask reticle or the like, other than a wafer.

What is claimed is:

1. A gas supply system for supplying a gas into a processing chamber for processing a substrate to be processed, the system comprising:
a processing gas supply unit for supplying a processing gas for processing the substrate to be processed;
a processing gas supply line for allowing the processing gas from the processing gas supply unit to flow therein;
a first and a second branch line branched from the processing gas supply line to be respectively connected with a first and a second gas introduction section for introducing a gas from different portions in the processing chamber;
a branch flow control unit for controlling branch flows of the processing gas distributed from the processing gas supply line to the first and the second branch line based on pressures in the first and the second processing gas branch line;
an additional gas supply unit for supplying an additional gas; and
an additional gas supply line for allowing the additional gas to flow therein,
wherein the first gas introduction section or the second gas introduction section is divided into a processing gas introduction section connected with the branch lines and an additional gas introduction section connected with the additional gas supply line.

2. The system of claim 1, wherein the additional gas introduction section introduces the additional gas into the processing chamber to be added to the processing gas introduced from the processing gas introduction section into the processing chamber.

3. The system of claim 1, wherein the second gas introduction section is arranged to surround the first gas introduction section and divided into the processing gas introduction section and the additional gas introduction section, the processing gas introduction section being arranged to surround the first gas introduction section, the additional gas introduction section being arranged to surround the processing gas introduction section.

4. The system of claim 1, further comprising a control unit for controlling, before the substrate is processed, the processing gas supply unit and the additional gas supply unit to initiate supplies of the processing gas and the additional gas and then controlling the branch flow control unit to adjust branch flows of the processing gas such that a ratio of pressures in the branch lines becomes a target pressure ratio.

5. The system of claim 1, wherein the first gas introduction section is arranged such that the gas is introduced therethrough toward a central region on a surface of the substrate in the processing chamber, and wherein the second gas introduction section is arranged such that the gas is introduced therethrough toward an outer peripheral region surrounding the central region on the surface of the substrate.

6. The system of claim 1, wherein the branch flow control unit has valves for controlling a flow rate of the processing gas flowing in the respective branch lines and pressure sensors for detecting the pressures in the respective branch lines, and a ratio of flow rates of the processing gas flowing through the respective branch lines is adjusted by controlling opening degrees of the valves based on the inner pressures detected by the pressure sensors.

7. The system of claim 1, wherein the processing gas supply unit has a plurality of gas supply sources to supply to the processing gas supply line the processing gas obtained by mixing gases from the gas supply sources at a specific flow rate ratio.

8. The system of claim 1, wherein the additional gas supply unit has a plurality of gas supply sources to supply to the additional gas supply line the additional gas obtained by selecting a gas from the gas supply sources or by mixing gases from the gas supply sources at a specific gas flow rate ratio.

9. A gas supply system for supplying a gas into a processing chamber for processing a substrate to be processed, the system comprising:
a processing gas supply unit for supplying a processing gas for processing the substrate to be processed;
a processing gas supply line for allowing the processing gas from the processing gas supply unit to flow therein;
a first to an n-th branch line branched from the processing gas supply line to be respectively connected with a first to an n-th gas introduction section for introducing a gas from different portions in the processing chamber;
a branch flow control unit for controlling branch flows of the processing gas distributed from the processing gas supply line to the first to the n-th branch line based on pressures in the first to the n-th branch line;
an additional gas supply unit for supplying an additional gas; and
an additional gas supply line for allowing the additional gas to flow therein,
wherein at least one of the first to the n-th gas introduction section is divided into a processing gas introduction section for introducing the processing gas from the branch lines into the processing chamber and an additional gas introduction section for introducing the additional gas from the additional gas supply line into the processing chamber to be added to the processing gas.

10. A gas supply system for supplying a gas into a processing chamber for processing a substrate to be processed, the system comprising:
a processing gas supply unit for supplying a processing gas for processing the substrate to be processed;
a processing gas supply line for allowing the processing gas from the processing gas supply unit to flow therein;
a plurality of branch lines branched from the processing gas supply line to be respectively connected with a plurality of gas introduction sections for introducing a gas from different portions in the processing chamber;
a branch flow control unit for controlling branch flows of the processing gas distributed from the processing gas supply line to the branch lines based on inner pressures of the branch lines;
an additional gas supply unit for supplying an additional gas; and
an additional gas supply line for allowing the additional gas to flow therein,
wherein at least one of the gas introduction sections is divided into a processing gas introduction section for introducing the processing gas from the branch lines into the processing chamber and an additional gas introduction section for introducing the additional gas from the additional gas supply line to be added to the processing gas.

11. A substrate processing apparatus comprising:
a processing chamber for processing a substrate to be processed; and
a gas supply system for supplying a gas into the processing chamber,
wherein the gas supply system comprises a first and a second gas introduction section for introducing a gas from different portions in the processing chamber; a processing gas supply unit for supplying a processing gas for processing the substrate to be processed; a processing gas supply line for allowing the processing gas from the processing gas supply unit to flow therein; a first and a second branch line branched from the processing gas supply line to be respectively connected with the first and the second gas introduction section; a branch flow control unit for controlling branch flows of the processing gas distributed from the processing gas supply line to the first and the second branch line based on pressures in the first and the second branch line; an additional gas supply unit for supplying an additional gas; an additional gas supply for allowing the additional gas from the additional gas supply unit to flow therein,
wherein the first gas introduction section or the second gas introduction section is divided into a processing gas introduction section connected with the branch lines and an additional gas introduction section connected with the additional gas supply line.

12. The apparatus of claim 11, wherein the additional gas introduction section introduces the additional gas into the processing chamber to be added to the processing gas introduced from the processing gas introduction section into the processing chamber.

13. The apparatus of claim 11, wherein the second gas introduction section is arranged to surround the first gas introduction section and divided into the processing gas introduction section and the additional gas introduction section, the processing gas introduction section being arranged to surround the first gas introduction section and the additional gas introduction section being arranged to surround the processing gas introduction section.

14. The apparatus of claim 11, further comprising a control unit for controlling, before the substrate is processed, the processing gas supply unit and the additional gas supply unit to initiate supplies of the processing gas and the additional gas and then controlling the branch flow control unit to adjust the branch flows of the processing gas from the processing gas supply line such that a ratio of the pressures in the branch lines becomes a target pressure ratio.

15. A gas supply method using a gas supply system for supplying a gas into a processing chamber for processing a substrate to be processed, the gas supply system including a processing gas supply unit for supplying a processing gas for processing the substrate to be processed; a processing gas supply line for allowing the processing gas from the processing gas supply unit to flow therein; a first and a second branch line branched from the processing gas supply line to be respectively connected with a first and a second gas introduction section for introducing a gas from different portions in the processing chamber; a branch flow control unit for adjusting branch flows of the processing gas distributed from the processing gas supply line to the first and the second branch line based on pressures in the first and the second branch line; an additional gas supply unit for supplying an additional gas; and an additional gas supply line for allowing the additional gas from the additional gas supply unit to flow therein, wherein the first gas introduction section or the second gas introduction section is divided into a processing gas introduction section connected with the branch lines and an additional gas introduction section connected with the additional gas supply line, the method comprising the steps of:
controlling, before processing the substrate to be processed, the processing gas supply unit and the additional gas supply unit to initiate supplies of the processing gas and the additional gas; and
controlling the branch flow control unit to adjust the branch flows of the processing gas such that a ratio of the pressure in the branch lines becomes a target pressure ratio
